(19) United States
(12) Patent Application Publication
(10) Pub. No.: US 2008/0235477 A1
(43) Pub. Date: Sep. 25, 2008

(54) COHERENT DATA MOVER

(76) Inventor: Andrew R. Rawson, Austin, TX (US)

Correspondence Address: MEYERTONS, HOOD, KIVLIN, KOWERT & GOETZEL (AMD), P.O. BOX 398, AUSTIN, TX, 78767-0398, US

(21) Appl. No.: 11/688,017

(22) Filed: Mar. 19, 2007

(51) Int. Cl. G06F 12/00

(52) U.S. Cl. 711/165

(57) ABSTRACT

A method and system for dynamically relocating regions of memory in computing systems. During the execution of software application(s) on a computing system, a relocation of data in a region of memory may be performed. A coherent data mover is coupled to system memory, memory controller(s), and processor(s) of a computing system. The mover executes commands such as copying a specific region of memory from its current source location in system memory to a new target location in system memory without suspending access of the data. During a copy of data from the first portion to the second portion, the mover monitors transactions which modify data in the first portion which has already been copied. Subsequent to copying all of the data, the mover re-copies those data elements which were detected to be modified during the copy operation.

### BACKGROUND OF THE INVENTION

1. Field of the Invention

This invention relates to computing systems, and more particularly, to coherent data movement in a memory of the computing system.

2. Description of the Relevant Art

In computing systems, a physical move of data from one location of memory to another location may better suit execution of application(s) or other aspects of system operation. Some reasons for performing such a relocation may include a change in resources such as failing hardware components, hot add/removal of hardware components where the components are added/removed while applications are running, and change in availability of hardware resources due to power management techniques. Also, optimizing load balances is another reason for wanting a relocation benefit. For example, a virtual machine monitor (VMM) operating at a hypervisor or other level may wish to dynamically relocate regions of memory in the physical address space in order to optimize the location of data being used by processors executing applications corresponding to a guest operating system. Another example is a guest operating system running at a supervisor level may wish to dynamically relocate regions of memory in order to optimize the location of data being used by executing threads that the guest operating system is scheduling.

Currently, whether the data dynamic relocation request is performed at the hypervisor, supervisor, or other level, an executing application using the data must generally wait before continuing to use the data until the move has been completed. However, the region of memory to be moved may be large and require a substantial amount of time for the relocation. Consequently, a computing system that has executing applications stalled during memory region reallocation experiences a performance penalty.

### SUMMARY OF THE INVENTION

Systems and methods for dynamically relocating regions of memory in computing systems are disclosed. In one embodiment, a coherent data mover or simply “mover”, is incorporated in a computing system. The mover may be coupled to at least system memory, memory controller(s), a system network, and processor(s). To initiate a coherent data move, a software process may be executed by an operating system (OS) or a virtual machine monitor (VMM), and may place a command list in system memory. The mover accesses this location in system memory and executes the commands in the list. One or more commands may instruct the mover to move a specified region of memory from its current source location in system memory to a new target location in system memory. In another embodiment, the coherent data mover in conjunction with a remote DMA engine is configured to move data from the memory space of one processing node to the disjoint memory space of second processing node. In one embodiment, a processing node may comprise one or more processors, each having some segment of system memory either directly attached or attached via a memory controller. A processing node may either share the same system memory address space with another processing node (e.g., in the case of an SMP system) or may have a disjoint system memory address space (such as in the case of a cluster).

While the mover executes such a copy command, the mover monitors network transactions within the computing system that may modify data or potentially modify data by obtaining exclusive ownership of the data in the source location in system memory whose copy has already been relocated to the target location in system memory. A trace buffer may store a list of addresses of such data. As used herein, modify may refer to the actual modifying of data by a transaction or the potential of modifying of data by a transaction gaining exclusive right to the data. Upon completion of the copy of the entire specified region of memory in the source location, the mover may write its completion status to a completion status buffer in system memory or a register within the mover. The completion status may include a notification that data in the source location already copied to the target location were modified during the execution of the copy command. Such notification indicates the need for the next step in which an update is performed in the target location of the data with addresses stored in the trace buffer. During this update, access to the source location may be temporarily suspended. Then remapping of address translations occurs followed by removal of the suspension of the use of data. Applications may resume execution and now access the region of memory in the target location.

These and other embodiments will become apparent upon consideration of the following description and accompanying drawings.

### BRIEF DESCRIPTION OF THE DRAWINGS

FIG. 1 is a block diagram illustrating a multiprocessor computing system including external input/output devices.

FIG. 2 is block diagram of a multiprocessor computing system including a coherent data mover to aid in dynamic relocation of regions of system memory.

FIG. 3 is a flow diagram illustrating one embodiment of a method for coherent dynamic data relocation within system memory.

FIG. 4 is a block diagram illustrating one embodiment of the contents of portions of the coherent data mover and system memory data during a movement operation.

FIG. 5 is a block diagram illustrating one embodiment of the consistency monitor and trace buffer.

FIG. 6 is a block diagram illustrating one embodiment of the mover engine.

While the invention is susceptible to various modifications and alternative forms, specific embodiments are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the spirit and scope of the present invention as defined by the appended claims.

### DETAILED DESCRIPTION

Increased performance of a computing system may be obtained by techniques that improve the utilization of available hardware resources during execution of applications and other software (e.g., operating systems, device drivers, and virtual machine monitor software). For example, code and/or data for a particular application may need to be moved during application execution for several reasons. As used herein, both code and data of an application may be collectively referred to as data. A move operation of data from a source location to a target location may comprise reading the data from the source location and writing a copy of the data to the target location. The data in the source location may be invalidated at a later time upon completion of the movement of the data. As previously noted, one reason for a move operation is a virtual machine monitor (VMM) operating at a hypervisor level may wish to move data being used by an operating system (OS) and its software applications to a different location within system memory in order to optimize the location of the data relative to the processors executing the applications. Another reason may be the VMM needs to perform load balancing due to changes in hardware resources. Such changes may result from power management techniques, an addition and/or removal of hardware resources as applications continue to execute, or failing hardware components such as a failing processing node. Another reason for a move operation may be the OS functioning at the supervisor level may wish to move data within a physical address space being used by processes and threads being scheduled by the operating system.

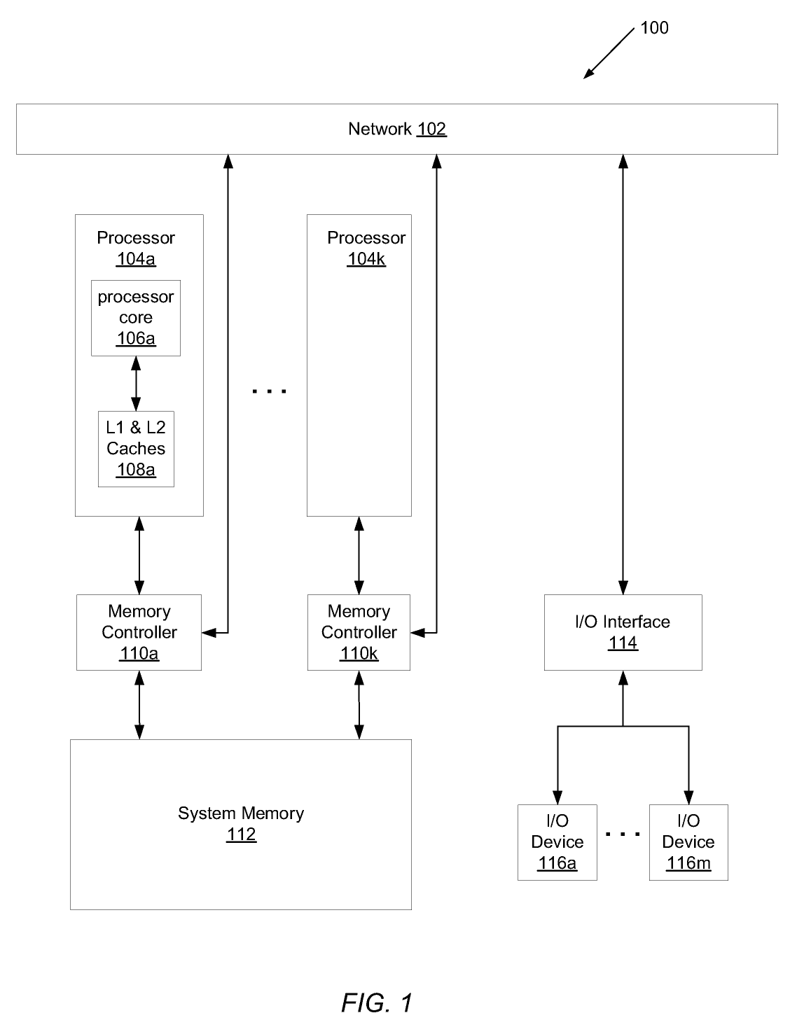

Referring to FIG. 1, one embodiment of a computing system 100 is shown. A network 102 may include remote direct memory access (RDMA) hardware and/or software. Interfaces between network 102 and memory controller 110a-110k and I/O Interface 114 may comprise any suitable technology. I/O Interface 114 may comprise a memory management unit for I/O Devices 116a-116m. As used herein, elements referred to by a reference numeral followed by a letter may be collectively referred to by the numeral alone. For example, memory controllers 110a-110k may be collectively referred to as memory controllers 110. As shown, each memory controller 110 may be coupled to a processor 104. Each processor 104 may comprise a processor core 106 and one or more levels of caches 108. In alternative embodiments, each processor 104 may comprise multiple processor cores. The memory controller 110 is coupled to system memory 112, which may include primary memory of RAM for processors 104. Alternatively, each processor 104 may be directly coupled to its own RAM. In this case each processor would also directly connect to network 102.

In alternative embodiments, more than one processor 104 may be coupled to memory controller 110. In such an embodiment, system memory 112 may be split into multiple segments with a segment of system memory 112 coupled to each of the multiple processors or to memory controller 110. In one embodiment, the group of processors, a memory controller 110, and a segment of system memory 112 may form a processing node. Also, the group of processors with segments of system memory 112 coupled directly to each processor may form a processing node. A processing node may communicate with other processing nodes via network 102 in either a coherent or non-coherent fashion. In a cluster system, a processing node may comprise a collection of one or more processors with one or more cores, one or more levels of caches per processor, and a region of system memory where the system memory space of each processing node is disjoint from every other processing node. Those skilled in the art will appreciate various embodiments of a processing node are possible. All such variations are contemplated.

In one embodiment, system 100 may have one or more OS(s) for each node and a VMM for the entire system. In other embodiments, system 100 may have one OS for the entire system. In yet another embodiment, each processing node may employ a separate and disjoint address space and host a separate VMM managing one or more guest operating systems.

An I/O Interface 114 is coupled to both network 102 and I/O devices 116a-116m. I/O devices 116 may include peripheral network devices such as printers, keyboards, monitors, cameras, card readers, hard disk drives and otherwise. Each I/O device 116 may have a device ID assigned to it, such as a PCI ID. The I/O Interface 114 may use the device ID to determine the address space assigned to the I/O device 116. For example, a mapping table indexed by the device ID may provide a page table pointer to the appropriate page table for mapping the peripheral address space to the system memory address space.

In one embodiment, an OS or a VMM may determine that data within system memory 112 needs to move to optimize application execution on processor 104a, for example, or to offset the effects of a failing node comprising processor 104k, for example. However, currently, the software, either an OS or a VMM, that performs the data move must suspend the use of the data by processor 104a and any I/O devices 116 until the move is complete. Then operations on the data may begin again. This suspension of data use reduces the performance of computing system 100 and an alternative method is desired.

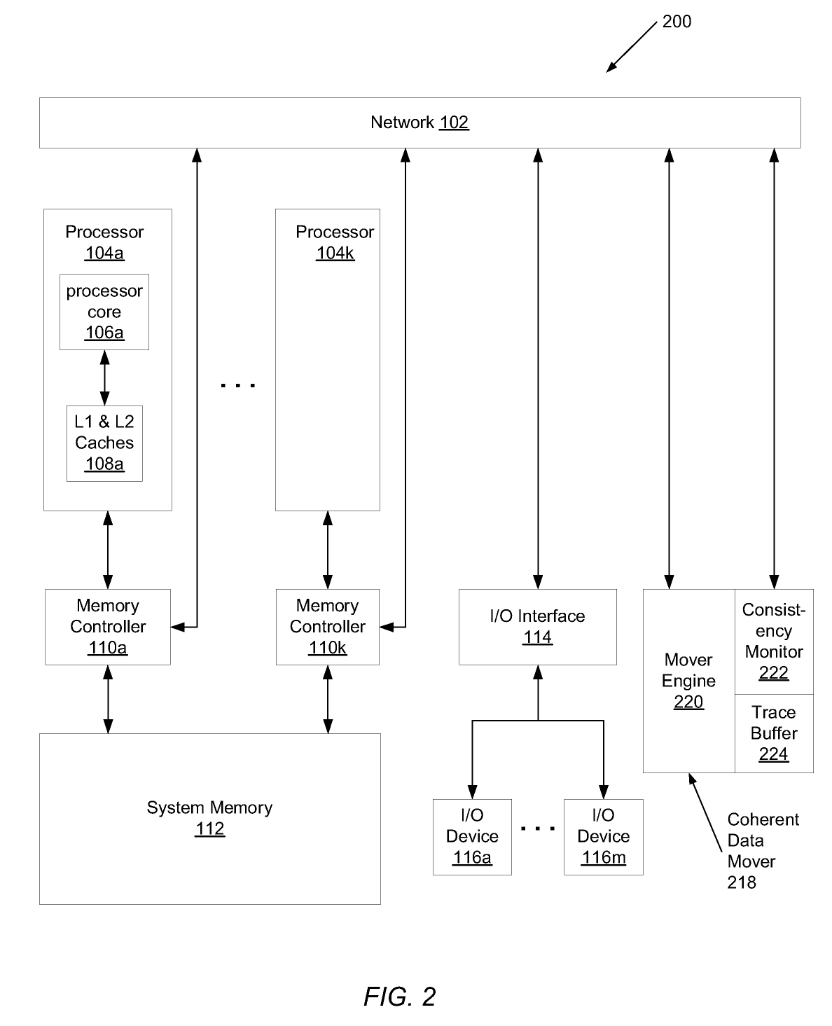

Referring now to FIG. 2, one embodiment of a computing system 200 with a coherent data mover 218 is illustrated. Coherent data mover 218 comprises hardware and/or software that may be used to move data in system memory 112 from a source region of physical address space to a target region of physical address space without suspending the use of the data by processors 104 or I/O devices 116. Alternative embodiments discussed above for FIG. 1 are possible here. In alternative embodiments, coherent data mover 218 may be coupled to system memory 112 via network 102 and no memory controller(s) 110. In another alternate embodiment, the coherent data mover may operate in concert with an RDMA engine to move data from the system memory of one processing node to the disjoint memory space of a second processing node.

The data movement effected by the coherent data mover is a non-blocking operation, so the data may be accessed and modified as it is being moved. Upon completion of the data movement, the mapping tables for both the processors 104 and I/O devices 116 are updated, so the translations are set to access the region of system memory 112 in the target region of physical address space. Any cached older translations may be invalidated at this time and the region of system memory 112 in the source region of physical address space may be overwritten. In one embodiment, both the source and target locations of data to be moved are specified to the coherent data mover by the OS or VMM in terms of their physical addresses and the coherent data mover 218 only operates with host physical addresses. In an alternative embodiment source and target locations may be specified in terms of either virtual or guest OS physical addresses necessitating that address translations be performed within the coherent data mover 218, which implies the translations are stored within the coherent data mover 218 or it accesses page tables in system memory 112 prior to or during the data movement. In this case the coherent data mover may cache these translations. Other alternatives exist for handling address translation during the data movement and the choice may depend on a number of different design trade-offs of the computing system.

In the embodiment shown, the coherent data mover 218 comprises a mover engine 220, a consistency monitor 222, and a trace buffer 224. To initiate a data move, software places a list of commands in a location in system memory 112. This location may change for another data move operation. One example of a command is a coherent copy command. This command may specify the start source and start target addresses, expressed as physical addresses or virtual addresses, and a number of data elements to copy. In one embodiment, a data element may be of any size that may be read in a single atomic operation depending on system design (e.g., a byte, a word, a double word, or quad word). Another example of a command is a write constant command that may specify a start target address, a constant datum to write, and a number of data elements to write. The command will write a constant datum into system memory 112 beginning at the source target address and continuing until the number of data elements specified in the command is satisfied. Another possible command is a randomize target command which causes the coherent data mover to write a stream of pseudo-random data to the target memory range.

During execution of the command list, the address modes may be made consistent. For example, a VMM may use host physical addresses, guest physical addresses, or virtual addresses to specify the location of source and target memory ranges in a coherent copy command. A guest OS may use either virtual or guest physical addresses and these need to be either translated in the coherent data mover 218 or a one-to-one mapping between host and guest physical addresses may be used. The processors 104 and I/O devices 116 may use virtual addresses or peripheral network addresses. The current translations between virtual addresses and host physical addresses may be determined during the decoding of the command list in system memory 112 by the mover engine 220 and during the read and write, and possibly copy, requests by the mover engine 220 for system memory 112. In addition, address translations in the data mover may be updated to reflect changes in translations in the TLB.

In the embodiment shown in system 200, the mover engine 220 accesses the location in system memory 112 via network 102 and a memory controller 110. When directed by an initiating software process, the mover engine 220 reads and executes the command list in order. For example, a coherent data copy command may be decoded by the mover engine 220. The mover engine 220 will perform a series of read and write, or possibly copy, transactions on system memory 112 in order to copy the data elements in the source region of memory to the target region of memory. The consistency monitor 222 monitors network 102 in order to detect any transaction that may modify data elements that have already been copied to the target region. In this case, the consistency monitor 222 notifies the trace buffer 224 to store the address corresponding to the data element that has been modified. This is a data element with an updated copy in the source region, but a stale copy in the target region. The consistency monitor 222 or control logic in the trace buffer 224 may search the trace buffer 224 in order to ensure that the corresponding address is not already stored in an entry in the trace buffer. This step will reduce the number of unnecessary updates upon the completion of the data movement. In an alternative embodiment, trace buffer 224 may be implemented in system memory 112 due to the potential large size of trace buffer 224.

In the case of a write constant command or a randomize target command, the consistency monitor would not need to monitor accesses by other processors or other entities to data within the source address range since the data is internally generated and not read from a source location in system memory. A further description of this process is given below.

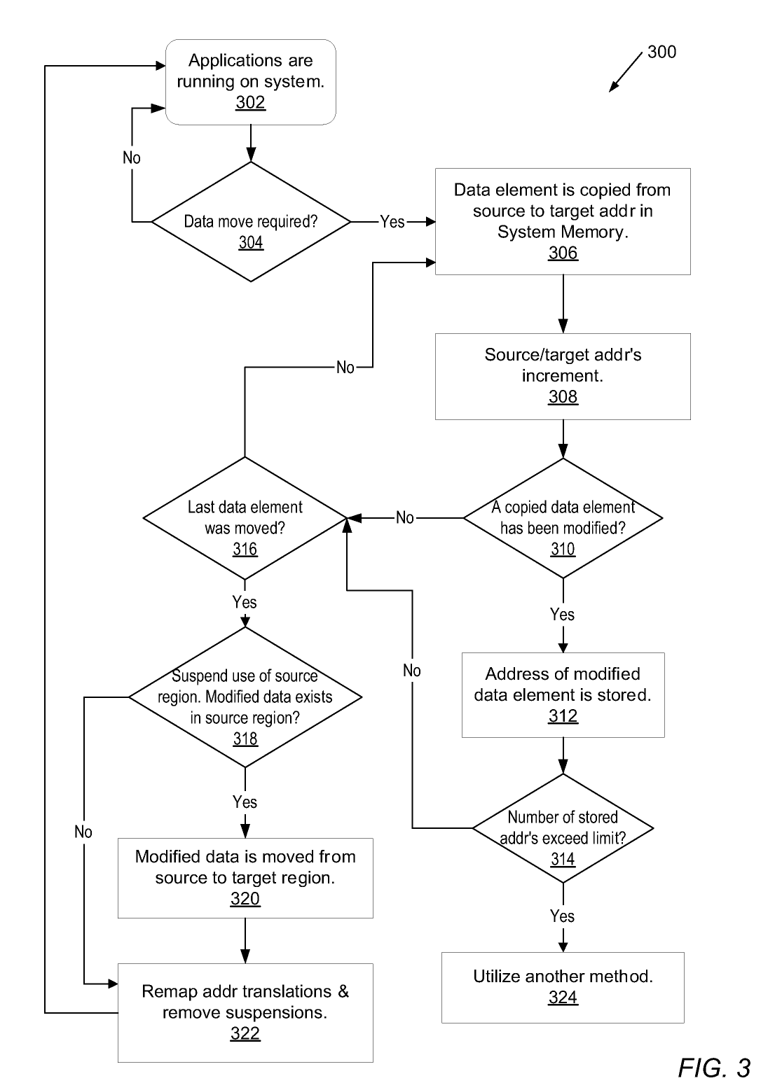

FIG. 3 illustrates a method 300 for performing a coherent and apparent atomic movement within system memory of a block of data using a plurality of atomic read and write, or possibly copy, transactions. The components embodied in the coherent data mover described above may operate in accordance with method 300. For purposes of discussion, the steps in this embodiment are shown in sequential order. However, some steps may occur in a different order than shown, some steps may be performed concurrently, some steps may be combined with other steps, and some steps may be absent in another embodiment.

In block 302, applications or other software are running on a computing system and system memory is being accessed. Some mechanism (e.g., OS, VMM, or otherwise), then determines that a region of memory is to be moved (decision block 304). Such a determination may be due to power management techniques, load balancing optimization, or other reasons. Software then writes a list of commands to a location in system memory that may include a coherent copy command. This location may change for a later, different data move operation. The software then instructs the mover engine within the coherent data mover to access this location and begin executing the commands in order.

After decoding the command, in block 306, the mover engine may perform a read and a write, or possibly a copy, operation in order to place a copy of the first data element, corresponding to the start source address in system memory, in the location of the start target address in system memory. The source and target addresses may be incremented in accordance with the size in bytes of the data element copied to traverse to the next data element to copy. Also, the consistency monitor may now be enabled (if not already enabled) by the mover engine (block 308). In one embodiment, the consistency monitor maintains at least the source addresses of the first and the last data element copied. These addresses represent a window of copied data elements which grows as the mover engine copies more data elements to the target region and the source address corresponding to the last data element copied is updated.

Also, the consistency monitor watches or monitors the network in order to detect any transaction from a processor, I/O device, or other entity that may modify data elements corresponding to addresses within the window being monitored. Processors caches, and I/O devices continue their read, write, and ownership requests as the copying from source to target regions occurs. If such a modifying transaction is detected (decision block 310), the corresponding address within the monitored window is recorded in the trace buffer within the coherent data mover (block 312). Otherwise, the mover engine checks if it has moved the last data element (decision block 316). In one embodiment, the trace buffer is sized so that the probability of it being filled, and possibly setting an overflow bit, during the coherent data move is relatively low. If the trace buffer does overflow (decision block 314), then an alternate data move method may be utilized (block 324). The alternate method must assume that all data elements in the source range have been modified since the information in the trace buffer is incomplete. However, if the trace buffer of addresses of stale data in the target region does not overflow, method 300 transitions to decision block 316.

If the mover engine has not moved the last data element, then method 300 returns to block 306 and the copying process continues. Otherwise, the mover engine has completed the data move from source to target region. The mover engine may write a completion status to system memory or internal register at this time. At the end of the data move, if there are any addresses in the trace buffer (decision block 318) then there exists data elements in the source region that have (or may have) been modified during the data move and the stale version of the corresponding data element resides in the target region. If there are no addresses in the trace buffer, or alternatively, a unique completion status signifying both the end of the data move and that the trace buffer is empty is sent from the data mover to system memory, then there is no need for software to check the trace buffer. Method 300 may transition to block 322.

Otherwise, for the case of addresses in the trace buffer, the mover engine may write a status to system memory corresponding to the stale data in the target region. Applications and software executing on the processors and I/O devices of the computing system that access the source region may be temporarily suspended by a software process (block 320). In between the time the mover wrote the completion status to system memory and the software process suspended access of data in the source location in system memory, the consistency monitor may continue to monitor transactions within the computing system that may modify data in the source location. With access of the source region suspended to running applications, the mover engine copies the modified data elements in the source region of the system memory, corresponding to the addresses in the trace buffer, to the target region. Thus, the stale data elements in the target region are replaced with their current values. If the trace buffer is empty upon completion of the data move, then the above second move of modified source data to the target region may be omitted.

Next, the address translations may be updated/re-mapped, the consistency monitor is reset, and the trace buffer is cleared (block 322). Suspension of the applications on the processors and the I/O devices is removed. Execution may continue and the target region of system memory is accessed (block 302).

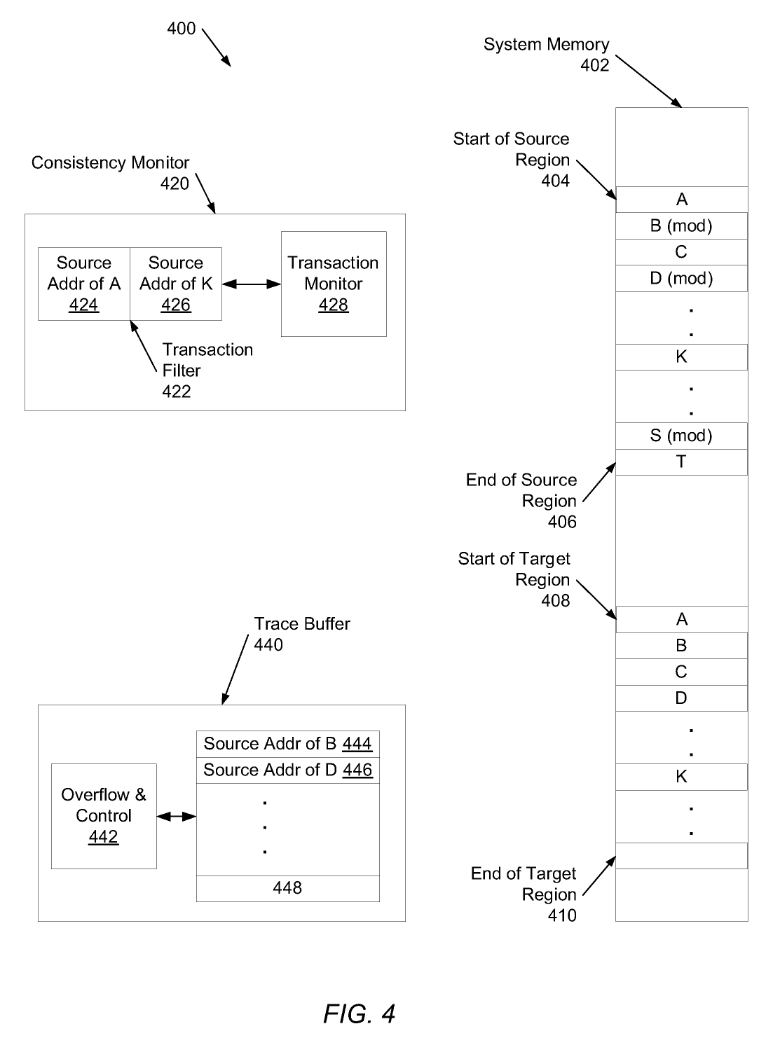

FIG. 4 shows one embodiment of a snapshot 400 of three components of a computing system during a coherent data move. System memory 402 has a source region delineated by a start address 404 and an end address 406 and a target region delineated by a start address 408 and an end address 410). The coherent data move process has already begun and data elements A-K have already been moved from the source region to the target region. Data elements B and D have been modified by a processor or I/O device or authority has been granted by the coherency mechanism to modify the data elements after they each have already been copied to the target region. Now the target region contains stale or potentially stale data for data elements B and D. Data element S has been modified by a processor or I/O device, but it has not been copied to the target region. Therefore, the target region does not contain a stale value for data element S and its corresponding source address is not stored in either the consistency monitor 420 or the trace buffer 440.

Consistency monitor 420 may comprise a transaction monitor 428 to monitor network traffic that may modify data elements in the source region that have already been copied to the target region. The transaction filter 422 maintains a window of addresses of data elements that have currently been copied. There is an address for the first data element copied, Source Address of A 424 and an address for the most recent data element copied, Source Address of K 426. These two addresses define the window for the transaction monitor 428 to monitor on a network, which is not shown.

Trace buffer 440 may comprise an overflow flag and control logic 442 and a buffer of addresses of data elements in the source region that have already been copied to the target region, and now may be stale in the target region. Data elements B and D have been modified in the source region after their values were copied to the target region. The transaction monitor 428 detected the modifications and now the trace buffer 440 contains the source addresses of these two data elements in 444 and 446. Other entries in the buffer including 448 are still empty. Note that further modifications or potential further modifications of data elements B and D, which may occur after these addresses are recorded in the trace buffer and before the trace buffer is read during the updating of stale data, do not need to be recorded again.

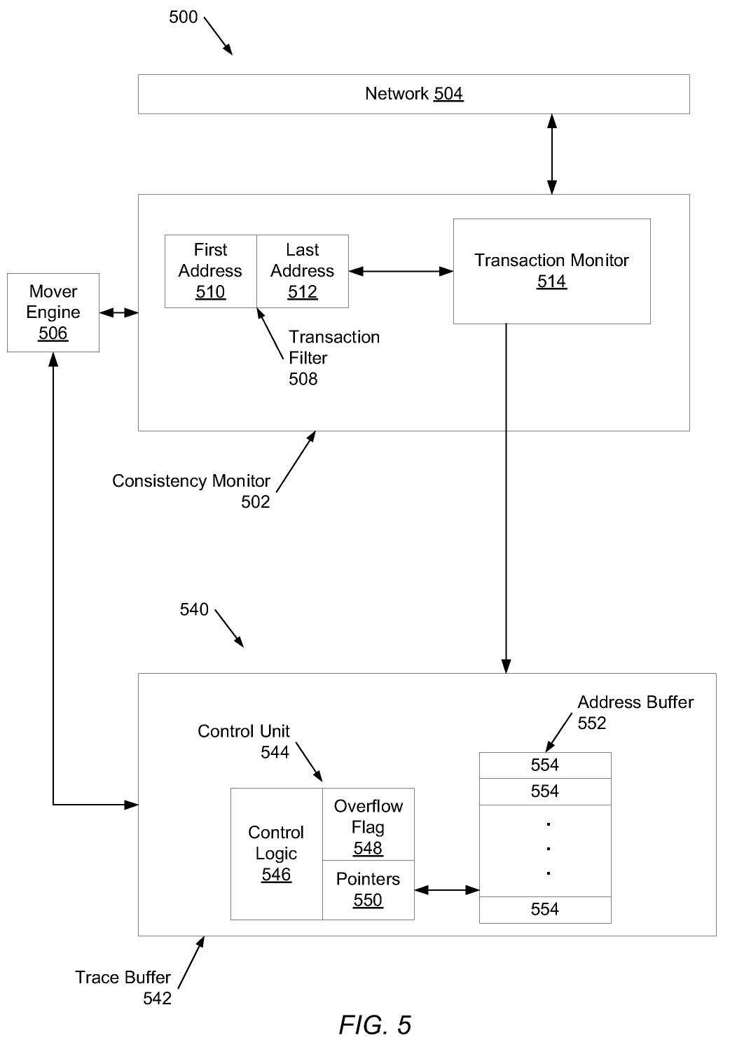

Referring now to FIG. 5, system 500 illustrates one embodiment of the consistency monitor 502. As described above in FIG. 4, a transaction filter 508 is updated by the mover engine 506 with addresses of data elements already moved. There is a source address of the first data element moved 510 and a source address of the latest data element moved 512. Transaction monitor 514 monitors network 504 for transactions by a processor, I/O device, or other entity that may modify data elements in the window of the source region specified by the transaction filter 508. If this occurs, the target region may contain stale data for the corresponding data element. The source address of this data element is sent to the trace buffer. Note that the region of memory being copied may wrap around memory so that address 512 has a value smaller than address 510. In this case the window of the source region will be those addresses greater than or equal to the value 510 and less than or equal to 512 using arithmetic modulo the size of physical memory. In another embodiment, the memory may be filled from a bottom-to-top manner so that the addresses may be decremented, rather than incremented as the memory fills. Then address 512 may have a value smaller than the value of address 510, but the window of the source region does include the memory lines physically between address 510 and address 512. Numerous such alternatives are possible and are contemplated.

FIG. 5 also illustrates one embodiment 540 of the trace buffer 542. The trace buffer 542 may contain a buffer of source addresses 552 where each entry 554 may contain a source address of a data element or a range of data elements that have been modified or potentially modified since it was copied and moved to the target region. In order to save trace buffer space, the trace buffer may store an address of a segment of memory greater than a data element. For example, one entry in the trace buffer may be an address corresponding to a coherency block (e.g., 64 bytes), a number of coherency blocks (e.g., 256 or 512 bytes), multiple 4K byte pages, or other. The start and end pointers of the address buffer 552 may be stored 550. They may be used to determine if the address buffer 552 overflows and a corresponding flag 548 is set. Control logic 546 may communicate with the mover engine 506 as the data move process executes and in the event of an overflow situation, the mover engine 506 is notified.

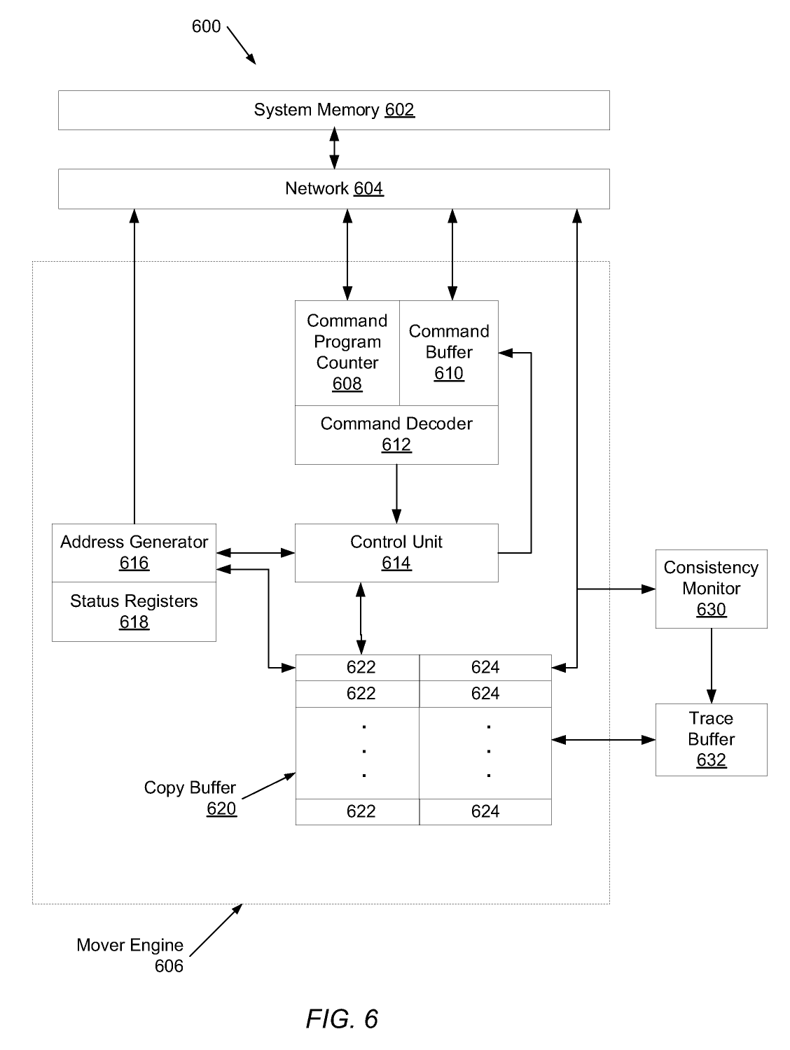

FIG. 6 illustrates one embodiment of the mover engine. System 600 has a system memory 602 with a source and a target region for the coherent data move. Network 604 maintains communication among the components of computing system 600 which may or may not include multiple processing nodes. Mover engine 606, consistency monitor 630, and trace buffer 632 together comprise the coherent data mover hardware which may perform a dynamic relocation of memory as processes execute on system 600.

Mover engine 606 may include a command program counter 608 and a command buffer 610 to process the location in system memory 602 that stores a list of commands for the mover engine to execute. When the software process that assembles the command list in system memory completes its task, the software process passes a pointer corresponding to the beginning of the list to the mover engine. This pointer is loaded into the command program counter 608 and used to read the commands from system memory and placed in command buffer 610. The command decoder 612 may decode the command (e.g., coherent copy command, write constant command).

A control unit 614 executes the command and may use an address generator 616 and copy buffer 620 to move data from a location in the source region to a location in the target region of system memory 602. Copy buffer 620 may have entries 622 for address translation mappings and entries 624 for storage of the data content of a data element being copied. Both of these entities may be stored elsewhere such as the translations 622 in the address generator 616 and the data element content 624 in other components of system 602. Status registers 618 may be used for communication to an OS or VMM such as coherent data move completion status, stale target data status, overflow status, etc.

It is noted that the above-described embodiments may comprise software or a combination of hardware and software. In such an embodiment, the program instructions that implement the methods and/or mechanisms may be conveyed or stored on a computer accessible medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Still other forms of media configured to convey program instructions for access by a computing device include terrestrial and non-terrestrial communication links such as network, wireless, and satellite links on which electrical, electromagnetic, optical, or digital signals may be conveyed. Thus, various embodiments may further include receiving, sending or storing instructions and/or data implemented in accordance with the foregoing description upon a computer accessible medium.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A computing system comprising:
a memory including a first portion and a second portion, wherein the first portion comprises a plurality of memory locations; and
a data mover configured to:
copy data elements from the first portion to the second portion;
monitor transactions which may modify, or gain authority to potentially modify, data elements in the first portion while copying the data elements from the first portion to the second portion; and
re-copy particular data elements from the first portion to the second portion, in response to determining the particular data elements correspond to memory locations of the first portion which may have been modified subsequent to copying data elements from the memory locations to the second portion.

2. The system as recited in claim 1, wherein the data mover is further configured to:
store a first address of a memory location which corresponds to a beginning of the first portion;
store a second address identifying a memory location of a last data element moved to the second portion; and
monitor transactions which may modify memory locations within a window represented by the first address and the second address.

3. The system as recited in claim 2, wherein the data mover is further configured to:
repeatedly copy data element from the first portion to the second portion; and
update said second address.

4. The system as recited in claim 3, wherein the data mover is further configured to: store addresses of modified memory locations within said window; and
re-copy the modified memory locations from the first portion to the second portion.

5. The system as recited in claim 4, wherein the computing system is configured to: suspend use of said first portion prior to the data mover re-copying the modified memory locations.

6. The system as recited in claim 5, wherein the computing system is further configured to update address translation data to reflect a change in location of data from the first portion to the second portion.

7. The system as recited in claim 6, wherein the computing system is further configured to remove the suspension of use of said first portion upon completion of said update.

8. A method for use in a computing system, the method comprising:
copying data elements from a first portion of a memory comprising a plurality of memory locations to a second portion of the memory;
monitoring transactions which may modify data elements in the first portion while copying the data elements from the first portion to the second portion; and
re-copying particular data elements from the first portion to the second portion, in response to determining the particular data elements correspond to memory locations of the first portion which have been modified subsequent to copying data elements from the memory locations to the second portion.

9. The method as recited in claim 8, further comprising:
storing a first address of a memory location which corresponds to a beginning of the first portion;
storing a second address identifying a memory location of a last data element moved to the second portion; and
monitoring transactions which may modify memory locations within a window represented by the first address and the second address.

10. The method as recited in claim 9, further comprising: repeatedly copying data element from the first portion to the second portion; and
updating said second address.

11. The method as recited in claim 10, further comprising: storing addresses of modified memory locations within said window; and
re-copying memory locations which correspond to the stored addresses from the first portion to the second portion.

12. The method as recited in claim 11, further comprising suspending use of said first portion prior to re-copying the modified memory locations.

13. The method as recited in claim 12, further comprising updating address translation data to reflect a change in location of data from the first portion to the second portion.

14. The method as recited in claim 13, further comprising removing the suspension of use of said first portion upon completion of the update.

15. A data mover comprising:
a first buffer configured to store a first address and a second address; and
a second buffer configured to store addresses of modified memory locations;
an interface configured to communicate with a network interface; and
wherein the data mover is configured to:
copy data elements from the first portion to the second portion;
monitor transactions which may modify data elements in the first portion while copying the data elements from the first portion to the second portion; and
re-copy particular data elements from the first portion to the second portion, in response to determining the particular data elements correspond to memory locations of the first portion which have been modified subsequent to copying data elements from the memory locations to the second portion.

16. The data mover as recited in claim 15, wherein the first buffer is further configured to:
store a first address, which corresponds to a beginning of a first portion of a memory; and
store a second address, which corresponds to a last data element moved from the first portion to a second portion of the memory.

17. The data mover as recited in claim 16, wherein the second buffer is further configured to:
store addresses of modified memory locations within said first address and said second address in response to the modification occurs subsequent to the data mover copying the memory location from the first portion to the second portion.
